(19) United States
(12) Patent Application Publication
(10) Pub. No.: US 2026/0279133 A1
(43) Pub. Date: Sep. 17, 2026

(54) AUTOMATED RETAILER MACHINES AND METHODS OF OPERATING THE SAME

(71) Applicant: Digital Media Vending International LLC, Sebastopol, CA (US)

(72) Inventor: David ASHFORTH, Windsor, CA (US)

(73) Assignee: Digital Media Vending International LLC, Sebastopol, CA (US)

(21) Appl. No.: 19/080,136

(22) Filed: Mar. 14, 2025

(51) Int. Cl. G07F 17/00; G06K 19/07; H04W 4/50; H04W 8/22

(52) U.S. Cl. CPC G07F 17/0042; G06K 19/0723; H04W 4/50; H04W 8/22

(57) ABSTRACT

An automatic retailer machine comprising: a shelf configured to hold a plurality of mobile devices; a dispensing window; a movable hopper assembly configured to move a mobile device, from among the plurality of mobile devices, from the shelf to the dispensing window to dispense the mobile device; and at least one processor. The at least one processor is configured to execute computer-executable instructions to: control the movable hopper assembly to obtain device activation information from the mobile device; and cause the automatic retailer machine to initiate activation of the mobile device based on the device activation information.

### TECHNICAL FIELD

One or more example embodiments relate to automated retailer machines for dispensing products to customers.

### BACKGROUND

Automated retailer or vending machines are used to sell products such as electronics, cosmetics, and other consumer items, both inside and outside retail stores. Automated retailer machines provide the ability to sell merchandise without the need for a salesperson until the inventory in the automated retailer machine is empty and needs to be replenished.

### SUMMARY

The scope of protection sought for various example embodiments is set out by the independent claims. The example embodiments and/or features, if any, described in this specification that do not fall under the scope of the independent claims are to be interpreted as examples useful for understanding various embodiments.

Example embodiments provide automated retailer machines, methods and non-transitory computer-readable mediums to dispense products such as mobile (or cellular) devices to customers. In dispensing a mobile device, the automated retailer machine may activate the mobile device such that the device is configured to be used by the customer upon receipt.

At least one example embodiment provides an automatic retailer machine comprising: a shelf configured to hold a plurality of mobile devices; a dispensing window; a movable hopper assembly configured to move a mobile device, from among the plurality of mobile devices, from the shelf to the dispensing window to dispense the mobile device; and at least one processor configured to execute computer-executable instructions to control the movable hopper assembly to obtain device activation information from the mobile device, and cause the automatic retailer machine to initiate activation of the mobile device based on the device activation information.

At least one other example embodiment provides an automatic retailer machine comprising: a means for holding a plurality of mobile devices; a means for moving a mobile device, from among the plurality of mobile devices, from the shelf to a dispensing window to dispense the mobile device; a means for controlling the movable hopper assembly to obtain device activation information from the mobile device; and a means for causing the automatic retailer machine to initiate activation of the mobile device based on the device activation information.

At least one other example embodiment provides a non-transitory computer-readable storage medium storing computer-executable instructions that, when executed by at least one processor at an automatic retailer machine including at least one shelf holding a plurality of mobile devices, cause the automatic retailer machine to perform a method comprising: moving a movable hopper assembly to a shelf position at which a mobile device is arranged; obtaining device activation information from the mobile device; initiating activation of the mobile device based on the device activation information; and moving the mobile device from the shelf position to a dispensing window to dispense the mobile device.

At least one other example embodiment provides a method of operating an automatic retailer machine including at least one shelf holding a plurality of mobile devices, the method comprising: moving a movable hopper assembly to a shelf position at which a mobile device is arranged; obtaining device activation information from the mobile device; initiating activation of the mobile device based on the device activation information; and moving the mobile device from the shelf position to a dispensing window to dispense the mobile device.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of this disclosure.

FIG. 1 is a diagram illustrating a portion of an infrastructure for implementing one or more example embodiments.

FIG. 2A is a front view of an automated retailer machine according to an example embodiment.

FIG. 2B is a front perspective view of the automated retailer machine shown in FIG. 2A with the front panel removed.

FIG. 2C is a front perspective view of an example shelf of the automated retailer machine shown in FIGS. 2A and 2B.

FIG. 3A is front perspective view of a movable hopper assembly according to an example embodiment.

FIG. 3B is an enlarged front perspective view of the hopper shown in FIG. 3A.

FIG. 3C is an enlarged front view of the hopper shown in FIG. 3B.

FIG. 3D is an enlarged front perspective view of a hopper according to another example embodiment.

FIG. 3E is an enlarged front perspective view of a hopper according to yet another example embodiment.

FIG. 4 is a flow chart illustrating a method according to an example embodiment.

FIG. 5 is a flow chart illustrating a method for initiating device activation according to an example embodiment.

FIG. 6 is a flow chart illustrating a method for initiating device activation according to another example embodiment.

FIG. 7 is a simplified block diagram illustrating an example embodiment of components and electronic systems of the automated retailer machine shown in FIGS. 1, 2A and 2B.

FIG. 8 is a flow chart illustrating a method for performing device activation according to an example embodiment.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment and should not be interpreted as defining or limiting the range of values or properties encompassed by example embodiments. The use of similar or identical reference numbers in the various drawings is intended to indicate the presence of a similar or identical element or feature.

### DETAILED DESCRIPTION

Various example embodiments will now be described more fully with reference to the accompanying drawings in which some example embodiments are shown.

Detailed illustrative embodiments are disclosed herein. However, specific structural and functional details disclosed herein are merely representative for purposes of describing example embodiments. The example embodiments may, however, be embodied in many alternate forms and should not be construed as limited to only the embodiments set forth herein.

It should be understood that there is no intent to limit example embodiments to the particular forms disclosed. On the contrary, example embodiments are to cover all modifications, equivalents, and alternatives falling within the scope of this disclosure. Like numbers refer to like elements throughout the description of the figures.

As discussed herein the terminology “one or more” and “at least one” may be used interchangeably.

It will be appreciated that a number of example embodiments may be used in combination.

While operations in one or more flowcharts may be presented as occurring in series and in a certain order, example embodiments are not so limited. The operations may be performed in a different order and/or in parallel, and they may also be performed in an iterative manner.

Example embodiments will be discussed with regard to mobile devices (also referred to sometimes herein as cellular devices or simply devices) held in an automated retailer machine. However, example embodiments should not be limited to the examples described herein. Rather, example embodiments may be applicable to other electronic devices that are activated prior to use.

When discussing a representation or tag on a mobile device, it should be understood that the “device” may refer to the device including the packaging, wherein the representation or tag may be on the packaging of the device, or may refer to the device itself (e.g., without packaging or with clear packaging, wherein the representation or tag is on the device itself.

As discussed herein, device activation information may include an International Mobile Equipment Identity (IMEI), a Mobile Equipment Identifier (MEID), an Electronic Serial Number (ESN), and/or any other unique identification information for a mobile device.

As described herein, a mobile device may refer to a portable electronic device capable of communicating with one or more wireless networks (e.g., 3^{rd} Generation, 4^{th} Generation, 5th Generation, etc.) according to any suitable wireless protocol (e.g., GSM, GPRS, UMTS, HSPA(3G), LTE(4G), etc.). Example mobile devices include mobile phones, wearables, laptops or other portable electronic devices having wireless or cellular connectivity capabilities. As is generally known, mobile devices need not only be powered on, but also activated at the cellular carrier to access the cellular carrier's network to transmit and received voice and data. As discussed herein, activation of a mobile device refers to enabling the mobile device to access the cellular carrier network to transmit and receive voice and data over the network.

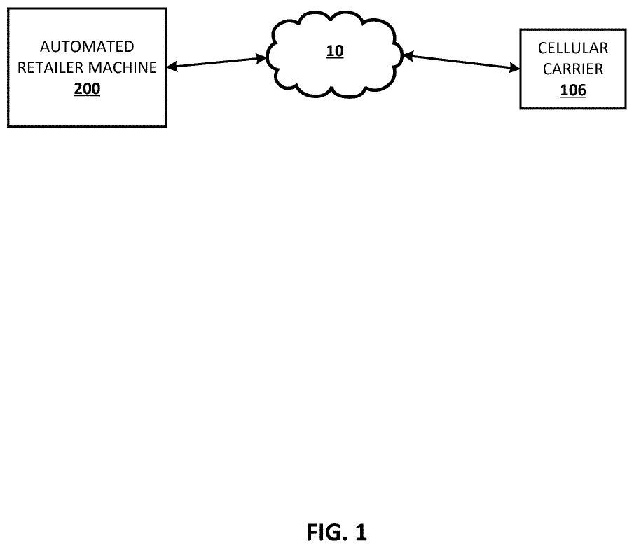

FIG. 1 is a diagram illustrating a portion of an infrastructure for implementing one or more example embodiments.

Referring to FIG. 1, the infrastructure includes an automated retailer machine 200 in two-way communication with a cellular carrier network 106 (also referred to as a cellular carrier). The automated retailer machine 200 and the cellular carrier network 106 may be positioned geographically separate from one another and communicate via one or more networks 10. The one or more networks 10 may be wired or wireless networks including, for example, the Internet. In one example, wireless networks may include cellular, WiFi, or other suitable networks. Wired networks may include Wide Area Networks (WANs), Local Area Networks (LANs), optical networks, or the like.

As will be discussed in more detail later, the automated retailer machine 200 may include a plurality of shelves that may be at least partially stocked with mobile devices configured to communicate with a wireless communications network, such as cellular carrier network 106. In operation, the automated retailer machine 200 may activate a mobile device and dispense the activated (or “hot”) mobile device to a customer such that the mobile device is capable of accessing a cellular carrier network immediately upon being dispensed from the automated retailer machine 200. Example functionality of the automated retailer machine 200 will be discussed in more detail later.

The cellular carrier network 106 may include network elements/components, for example, a radio access network (RAN) (e.g., base stations, etc.) and a core network including a backhaul network, servers, and the like, to provide communications capabilities to wireless devices. The cellular carrier network 106 may also represent one or more servers or other network elements to perform at least some of the functionality and operations described herein. Example operation of the cellular carrier network 106 according to one or more example embodiments will be discussed in more detail later.

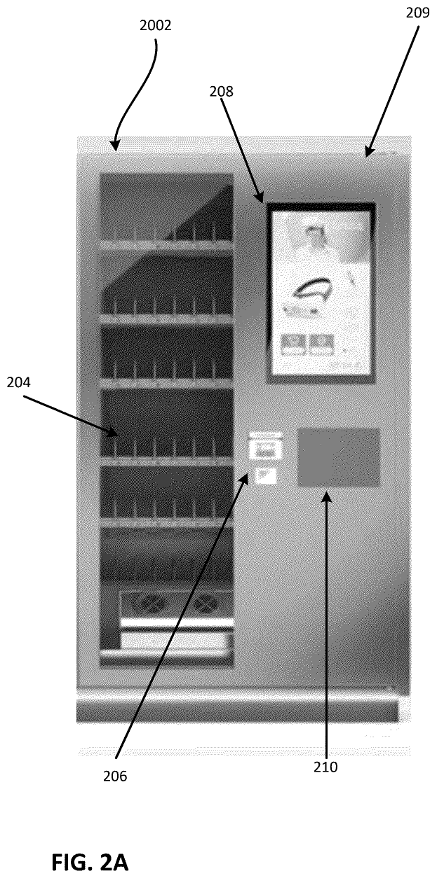

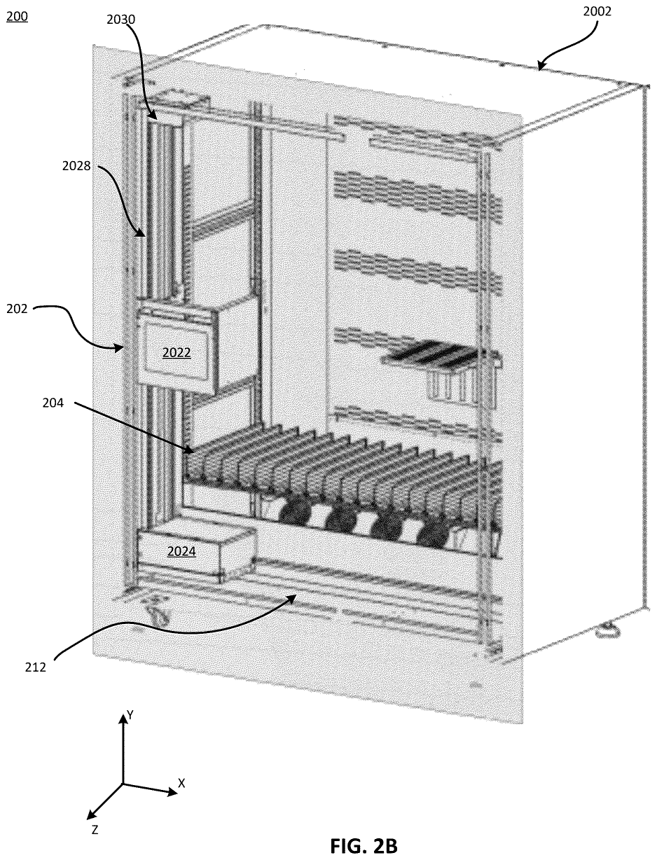

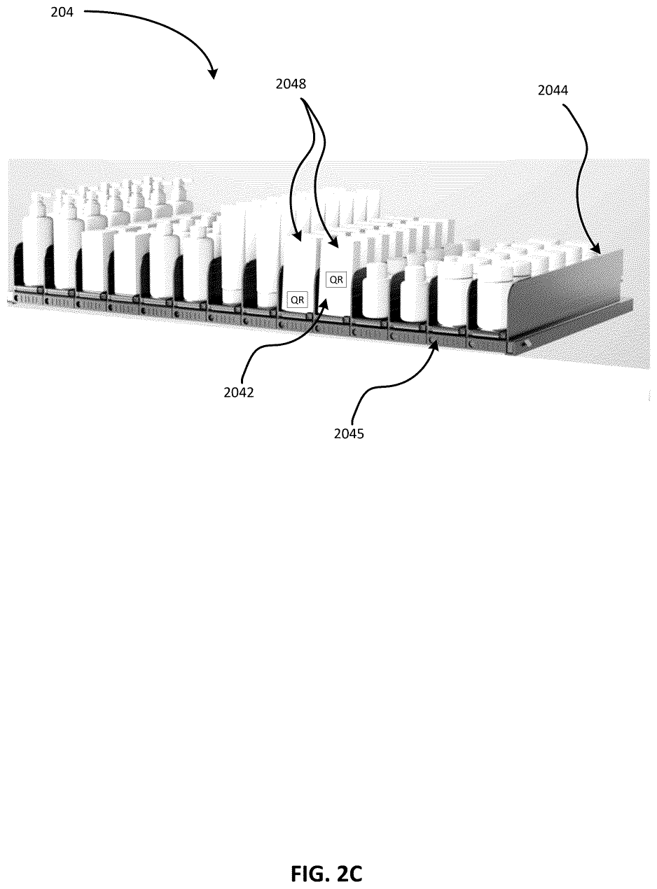

FIG. 2A is a front view of an automated retailer machine according to an example embodiment. FIG. 2B is a front perspective view of the automated retailer machine shown in FIG. 2A with the front panel removed.

Referring to FIGS. 2A and 2B, the automated retailer machine 200 includes dispenser shelves 204 configured to hold mobile devices (e.g., pre-packaged mobile devices) within a cabinet 2002. The cabinet 2002 includes a door 209 having a dispensing window 210. The cabinet 2002 may also have windows such that the shelves 204 and the mobile devices held thereon are visible by customers from outside the machine. The automated retailer machine 200 further includes an interface 208 and a payment terminal 206. In one example, the interface 208 may be a touch-enabled graphical user interface (GUI) display configured to display information regarding the mobile devices or other products held within the automated retailer machine 200 at any given time. The interface 208 also allows a customer to interact with the automated retailer machine 200 via, for example, a touch screen.

The payment terminal 206 may be any suitable payment terminal capable of receiving credit card, cash, contact-less (e.g., NFC-enabled) payments from a customer. Because payment terminals such as this are generally known, a detailed discussion is omitted.

As shown in FIG. 2B, the automated retailer machine 200 includes a movable hopper assembly 202. The movable hopper assembly 202 includes a hopper (also referred to as a dispensing bucket) 2022, a positioning control 2024, a y-positioning rail 2028 and an upper positioning member 2030. In some instances, the positioning control 2024, the y-positioning rail 2028 and the upper positioning member 2030 may be referred to as a positioning system or a hopper positioning system.

The movable hopper assembly 202 is configured to slide along upper rails (not shown) and lower rails 212 to move within the automated retailer machine 200 along the shelves 204 in the x-direction. The upper rails and the lower rails 212 may extend the length of the cabinet 2002 in the x-direction. In more detail, for example, the upper positioning member 2030 is configured to engage and slide along the upper rails and the positioning control 2024 is configured to engage and slide along the lower rails 212 to move the movable hopper assembly 202 in the x-direction within the automated retailer machine 200. The movement of the movable hopper assembly 202 is bi-directional so as to move from one side of the cabinet 2002 to the other and then back.

The hopper 2022 slides along the y-positioning rail 2028 to move in the y-direction.

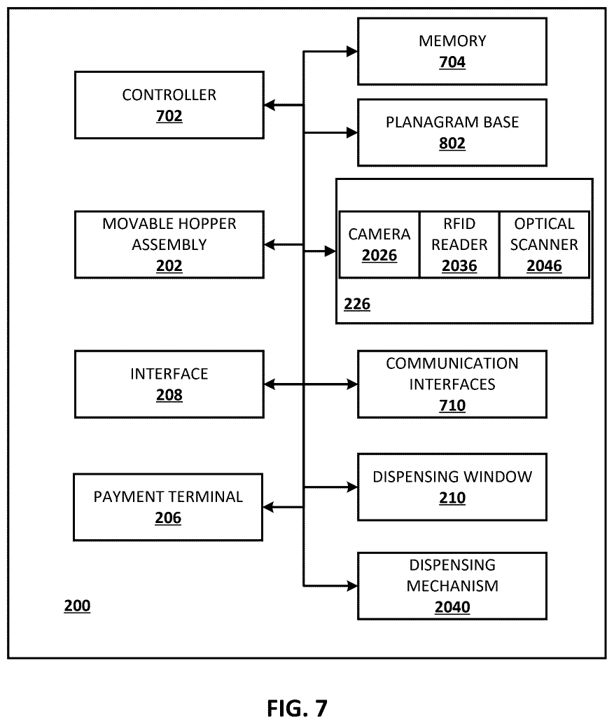

The positioning control 2024 includes control electronics and mechanics (e.g., gears, motors, actuators, pulleys, etc.) to move the movable hopper assembly 202 in the x-direction and to move the hopper 2022 in the y-direction within the automated retailer machine 200. In one example, the positioning control 2024 controls the movement of the movable hopper assembly 202 and the hopper 2022 according to control signals from a controller 702, which is discussed later with regard to FIG. 7. The hopper 2022 may be configured to reach each of the shelves 204 and also the dispensing window 210 to dispense mobile devices and/or other products held on the shelves 204.

In one example, the movable hopper assembly 202 moves to the correct position in the x-direction and then the hopper 2022 is raised to the correct position in the y-direction to retrieve a mobile device from the shelf 204. The movable hopper assembly 202 then moves the mobile device from the shelf 204 to the dispensing window 210 to dispense the mobile device to a customer. In one example, the hopper 2022 is lowered to the position of the dispensing window 210 in the y-direction, and then the movable hopper assembly 202 moves in the x-direction to position the hopper 2022 behind the dispensing window 210.

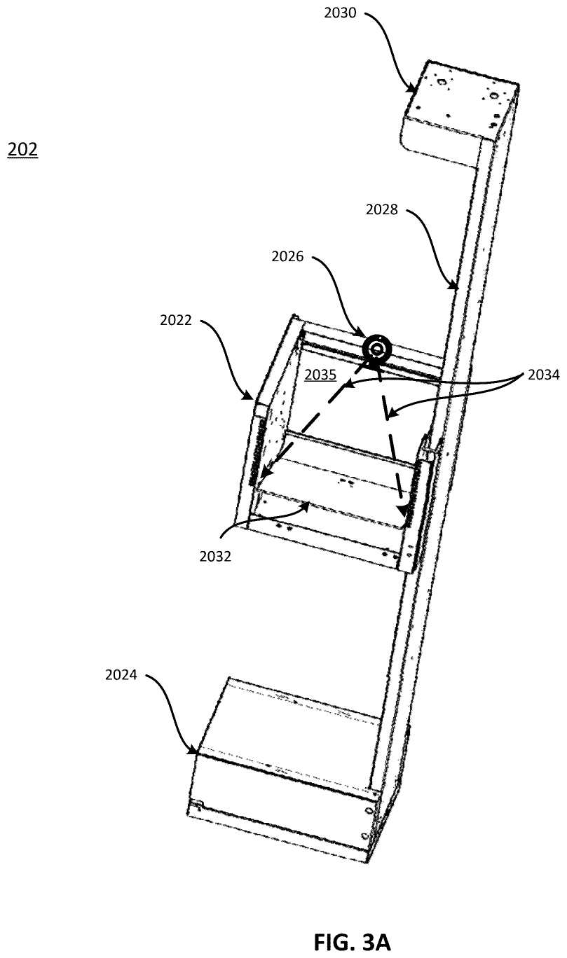

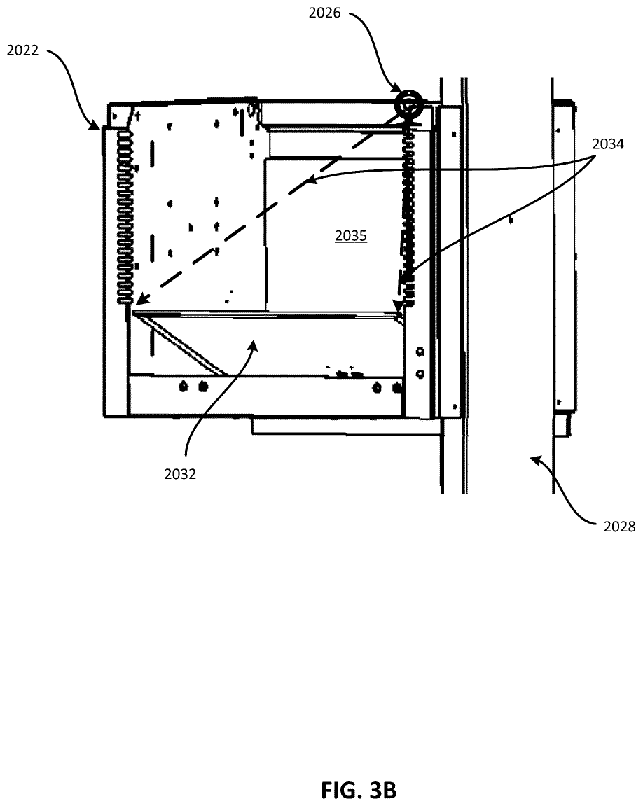

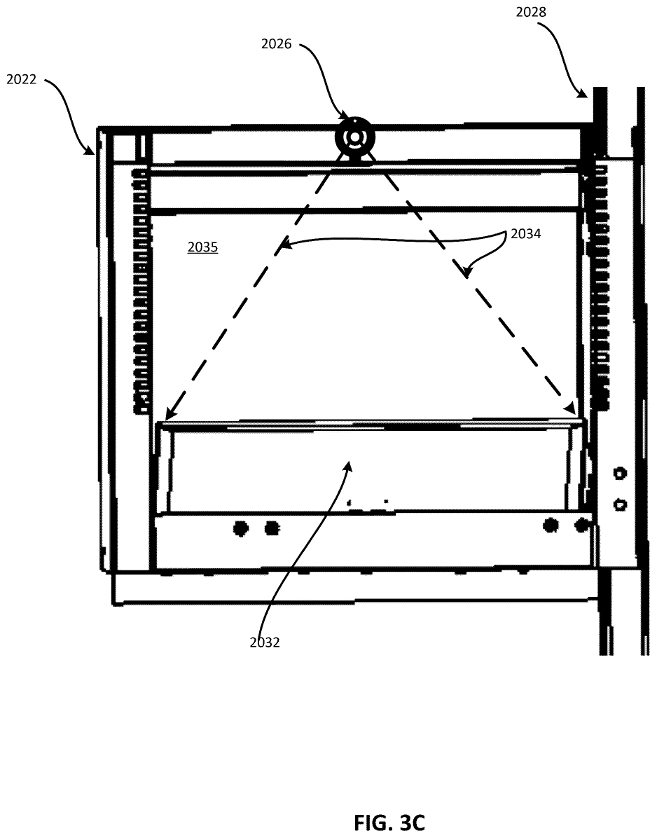

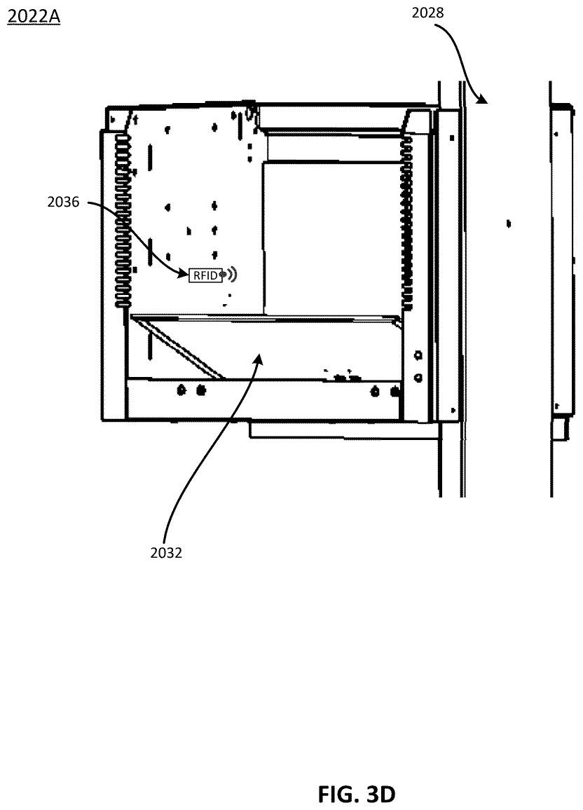

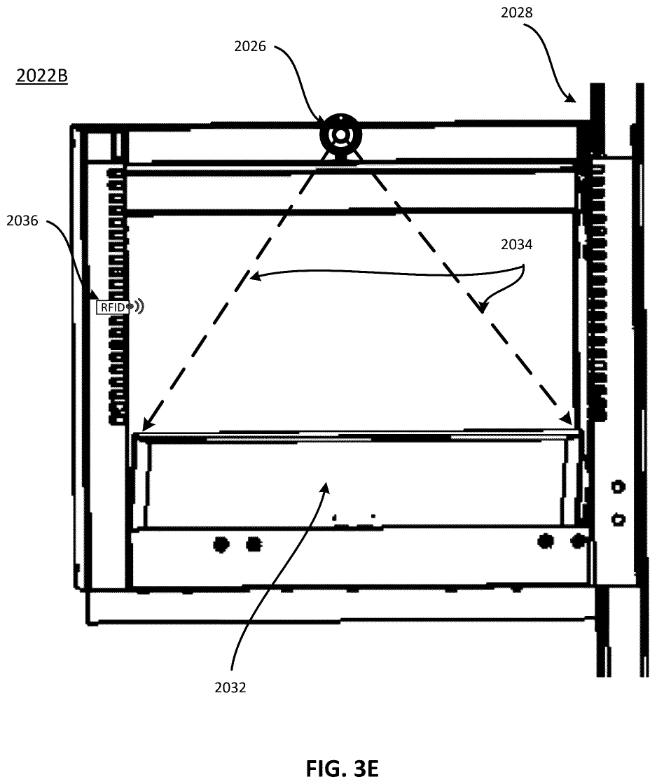

As will be discussed in more detail later, the hopper 2022 may include one or more capture devices. When in the correct x and y position to retrieve a mobile device from the shelf 204, the hopper 2022 may obtain device activation information or a representation thereof from the mobile device. As will also be discussed in more detail later, the one or more capture devices may include an image capture device (e.g., a camera), a Radio Frequency Identification (RFID) reader, an optical scanner, or the like. Example embodiments of the movable hopper assembly 202 and functionality thereof will be discussed in more detail with regard to FIGS. 3A-3E.

FIG. 2C is a front perspective view of an example shelf of the automated retailer machine shown in FIGS. 2A and 2B. As shown in FIG. 2C, the shelf 204 includes a base 2045 and dividers 2044 to separate rows of products, including mobile devices 2048, from one another. Among other things, the mobile devices 2048 held on the shelves of the automated retailer machine 200 may include a representation 2042 of device activation information for the mobile device 2048. In one example, the representation of the device activation information may be printed or fixed on a surface of the device or packaging of the device. Examples of the representation on the surface of the device and/or packaging include a machine readable code, such as a QR code, a barcode, conductive ink, or the like. Alternatively, the device activation information itself may be printed or fixed to the external surface of the device or the packaging thereof. In yet another example, an RFID tag including the device activation information may be included in the packaging, or may be fixed (e.g., temporarily) to the device or packaging thereof. Although various products are shown in FIG. 2C, it should be understood that each row of products may be the same or different.

Still referring to FIG. 2C, the base 2045 may have a dispenser mechanism to dispense products into the hopper when the hopper is moved into position under control of the controller 702. In one example, the dispenser mechanism may be a pushing member to feed products into the hopper when in position.

FIG. 7 is a simplified block diagram illustrating an example embodiment of components and electronic systems of the automated retailer machine shown in FIGS. 1, 2A and 2B.

Referring to FIG. 7, the system of the automated retailer machine 200 may include, among other things, one or more capture devices 226, the controller 702, memory 704, a planogram base 802, communication interfaces 710, the movable hopper assembly 202, the interface 208, the payment terminal 206, dispensing window 210 and dispensing mechanism 2040.

Referring to FIG. 7, the controller 702 is configured to control aspects of the system in accordance with methods according to one or more example embodiments described herein. The controller 702 may also control other, normal functions of the automated retailer machine 200. The controller 702 may be implemented by processing or control circuitry such as, but not limited to, one or more processors, one or more Central Processing Units (CPUs), one or more controllers, one or more arithmetic logic units (ALUs), one or more digital signal processors (DSPs), one or more microcomputers, one or more field programmable gate arrays (FPGAs), one or more System-on-Chips (SoCs), one or more programmable logic units (PLUs), one or more microprocessors, one or more Application Specific Integrated Circuits (ASICs), or any other device or devices capable of responding to and executing instructions in a defined manner. In one example, the controller 702 may be implemented by at least one processor configured to execute computer-executable instructions to cause the automatic retailer machine to perform functionality and operations described herein.

The communication interfaces 710 may include one or more wired or wireless communications interfaces configured to communicate via a wired or wireless communications network (e.g., a wired or wireless Local Area Network (LAN), wide area network (WAN), cellular network, the Internet) and/or using short range wireless communications, such as Bluetooth or the like. In at least one example, the communication interfaces 710 may be configured to communicate with the cellular carrier network 106 shown in FIG. 1.

In at least one example embodiment, the controller 702 controls the one or more capture devices 226 to obtain the device activation information or a representation thereof from the mobile device or packaging thereof within the automated retailer machine 200.

In one example, as noted similarly above, the one or more capture devices 226 may include a camera or other image capture device 2026 configured to capture an image of the representation of the device activation information for the device being dispensed by the automated retailer machine 200. The representation of the device activation information is discussed above with regard to FIG. 2C.

In another example, the image capture device 2026 may capture an image of the device activation information printed on the device or packaging of the device.

In yet another example, the representation may be a machine readable code and the one or more capture devices 226 may include an optical scanner 2046 configured to read the machine readable code on the device or the packaging of the device to obtain the device activation information.

In yet another example, the one or more capture devices 226 may include a RFID reader 2036. In this example, the device or device packaging may be equipped with a RFID tag (or transmitter) and the RFID reader 2036 may receive the device activation information from the RFID tag on the device or packaging of the device.

In another example, the controller 702 may control the one or more capture devices 226 to obtain a representation of a location of device activation information at a device activation information cloud repository (not shown) storing the device activation information for the devices held in the automated retailer machine 200. The location of the device activation information may be in the form of, for example, a weblink.

Although example embodiments are described herein with regard to the one or more capture devices 226 including one or more of a camera 2026, an RFID reader 2036 or an optical scanner 2046, example embodiments should not be limited to these examples.

Still referring to FIG. 7, the planogram base 802 may be a database or module storing a current planogram for the automated retailer machine 200. As is generally known, a planogram is a visual representation (e.g., diagram, map or plan) of the placement of products on shelves within the automated retailer machine.

In this example embodiment, the controller 702 may access the planogram base 802 and control the movable hopper assembly 202 according to the current planogram stored in the planogram base 802. The controller 702 may communicate with the movable hopper assembly 202 via one or more wired or wireless communication protocols. In one example, the controller 702 may communicate with (e.g., transmit and receive commands to) the movable hopper assembly 202 via a wired link and/or via a short range wireless communications protocol such as Bluetooth or the like.

Example embodiments of the movable hopper assembly 202 will be discussed in more detail below with regard to FIGS. 3A-3E.

FIG. 3A is a front perspective view of the movable hopper assembly 202 according to an example embodiment. FIG. 3B is an enlarged front perspective view of the hopper 2022 shown in FIG. 3A. FIG. 3C is an enlarged front view of the hopper 2022 shown in FIG. 3B. In the example embodiment shown in FIGS. 3A-3C, the hopper 2022 is shown from the point of view of a product on a shelf of the automated retailer machine 200 shown in FIGS. 2A and 2B. In this example, the capture device 226 is a camera 2026.

Referring to FIGS. 3A-3C, the hopper 2022 includes the camera 2026 mounted on a cubical frame to face the shelves 204 of the automated retailer machine 200. In more detail, the camera 2026 is mounted on an upper portion of the frame above the dispensing side of the hopper 2022. Although shown as a cubical frame in FIGS. 3A-3C, example embodiments should not be limited to this example. Additionally, although the camera 2026 is shown as mounted on the upper portion of the frame above the dispensing side of the hopper 2022, example embodiments should not be limited to this example. Rather, the camera 2026 may be mounted in other locations as needed.

The hopper 2022 further includes a flap 2032 and a hopper door 2035. The flap 2032 has a lowered (receiving) position in which it is a platform for receiving the mobile device from the shelf and a raised (dispensing) position causing the mobile device to slide forward toward the dispensing side of hopper 2022. The flap 2032 may be moved between the two positions by one or more motors (not shown) mounted on the hopper 2022 and/or within the positioning control 2024. The controller 702 may control the one or more motors to move the flap 2032. The hopper door 2035 is shown in the vertical position to retain the obtained mobile device within hopper 2022. When the hopper 2022 is positioned in the dispensing area behind the dispensing window 210, the hopper door 2035 and the dispensing window 210 may be opened such that a customer may remove the dispensed mobile device from the hopper 2022. The hopper door 2035 and/or the dispensing window 210 may be controlled by the controller 702 or opened manually.

The camera 2026 may capture a field of view 2034 that includes the interior of the hopper 2022, flap 2032, and mobile device(s), dispenser(s), and shelves at the current position of the hopper 2022. The camera 2026 is configured to, under the control of the controller 702, capture an image of the device and the representation of the device identification information on the device being dispensed. In another example, the camera 2026 may be configured to capture an image of the device and the device identification information on the device. The image from the camera 2026 may be a still image, a video image, or a combination thereof. The camera 2026 may send the captured image to the controller 702 and/or store the captured image in the memory 704. As discussed in more detail later, the controller 702 may process the captured image to obtain the device activation information for initiating activation of the device with the cellular carrier. In another example, the controller 702 may transmit the captured image to the cellular carrier for processing to obtain the device activation information and activate the device.

FIG. 3D is an enlarged front perspective view of a hopper 2022A according to another example embodiment.

The example embodiment of the hopper 2022A shown in FIG. 3D is similar to the hopper 2022 shown in FIGS. 3B and 3C, except that the hopper 2022A includes the RFID reader 2036 rather than the camera 2026. As discussed similarly above, in this example embodiment, the devices on the shelves may include a RFID tag (or transmitter) in addition to, or in place of, the machine readable code or device identification information. The RFID reader 2036 may be mounted on a sidewall of the hopper 2022A or any other portion of the hopper 2022A within reading range of the RFID tag on the device.

In the example embodiment shown in FIG. 3D, the RFID reader 2036 is configured to, under the control of the controller 702, read the RFID tag of the device to obtain the device activation information for the device being dispensed. The device activation information read by the RFID reader 2036 may be sent to the controller 702 and/or stored in the memory 704. The controller 702 may initiate activation of the device with the cellular carrier based on the device activation information obtained by the RFID reader 2036.

Because the example embodiment shown in FIG. 3D is otherwise the same or substantially the same as the example embodiment shown in FIGS. 3B and 3C, further discussion is omitted.

FIG. 3E is an enlarged front perspective view of a hopper 2022B according to another example embodiment.

The example embodiment of the hopper 2022B shown in FIG. 3E is similar to the hopper 2022 shown in FIGS. 3B and 3C, except that the hopper 2022B includes the camera 2026 and the RFID reader 2036. In this example embodiment, the devices on the shelves may have a machine readable code, the device activation information and/or an RFID tag. As with the example embodiment shown in FIG. 3D, the RFID reader 2036 may be mounted on a sidewall of the hopper 2022B or any other portion of the hopper 2022B within reading range of the RFID tag on the device. The camera 2026 may be positioned in the same or substantially the same position as in FIGS. 3B and 3C.

In this example embodiment, the controller 702 may control the camera 2026 to obtain an image as discussed above with regard to FIGS. 3B and 3C and/or control the RFID reader 2036 to read information from the RFID tag as discussed above with regard to FIG. 3D. In one example, the camera 2026 and the RFID reader 2036 may serve as a failsafe to one another in that if the camera 2026 fails, then the RFID reader 2036 may be used and vice versa. As with the example embodiment shown in FIGS. 3B and 3C and the example embodiment shown in FIG. 3D, the captured image and/or the information read by the RFID reader 2036 may be sent to the controller 702 and/or stored in the memory 704. The controller 702 may then use the device activation information to initiate activation of the device with the cellular carrier.

Because the example embodiment shown in FIG. 3E is otherwise the same or substantially the same as the example embodiment shown in FIGS. 3B and 3C, further discussion is omitted.

In yet another example embodiment, as discussed above, the one or more capture devices 226 may include the optical scanner 2046 as shown in FIG. 7. In one example, the optical scanner 2046 may be positioned on the hopper 2022 (FIGS. 3B and 3C) in the same or a similar position as the camera 2026. In this example, the optical scanner 2046 may read the machine readable code to obtain the device activation information and send the obtained device activation information to the controller 702. The controller 702 may then use the device activation information to initiate activation of the device with the cellular carrier.

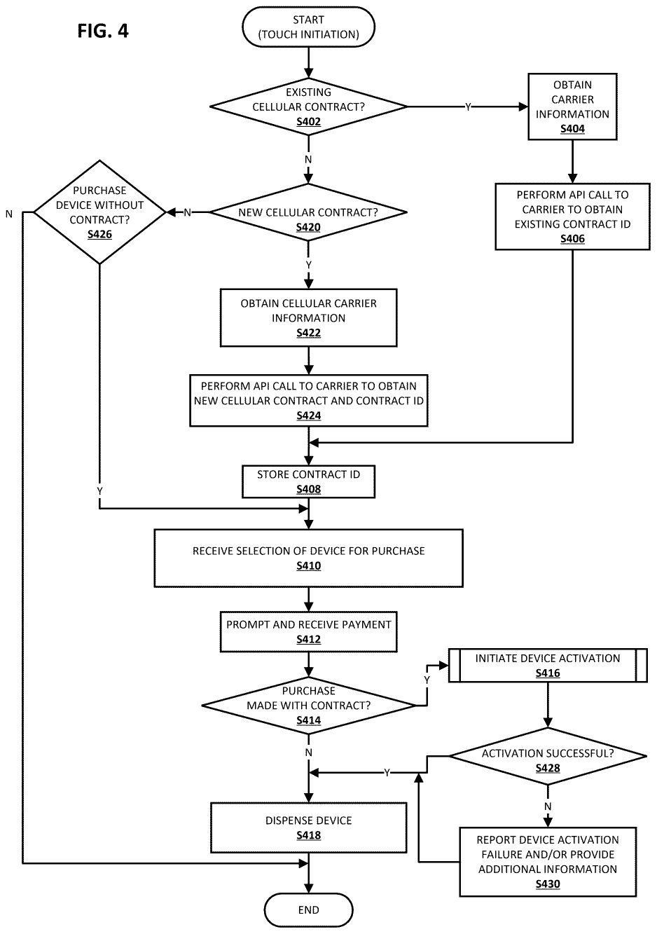

Example functionality of the automated retailer machine 200, components thereof and the cellular carrier 106, will now be discussed in more detail below with regard to FIGS. 4-6 and 8.

As noted above, one or more example embodiments provide automated retailer machines, methods and non-transitory computer-readable mediums to dispense products such as mobile devices to customers. In dispensing the mobile device, an automated retailer machine may activate a mobile device such that the mobile device is configured to be used by the customer upon receipt.

FIG. 4 is a flow chart illustrating a method according to an example embodiment. The method shown in FIG. 4 will be described with regard to the automated retailer machines described herein. However, example embodiments should not be limited to these examples.

Although example embodiments may be described, in some instances, with regard to operations/functions being performed by the automated retailer machine, it should be understood that the operations may be performed by and/or in conjunction with the controller 702 or other components of the automated retailer machine 200.

Referring to FIG. 4, upon approaching the automated retailer machine 200 to purchase a mobile device housed in the automated retailer machine 200, the customer may touch the interface to initiate the interaction with the machine. In another example, the customer may push a “start” or other button to initiate interaction with the machine.

At S402, the automated retailer machine 200 determines whether the customer has an existing wireless contract with a wireless carrier based on input from the customer via the interface 208. In one example, upon initiation of interaction by the customer, the interface 208 may prompt the customer to indicate whether they have an existing contract with a wireless cellular carrier. The customer may then indicate whether they have an existing contract with the wireless carrier by interacting with the interface 208 (e.g., pressing “YES” or “NO” on the interface 208).

If the automated retailer machine 200 determines that the customer does not have an existing wireless contract with the wireless carrier (e.g., the customer presses “NO”), then at S420 the automated retailer machine 200 determines whether a new contract with the cellular carrier is needed. In one example, the interface 208 may prompt the customer to indicate whether they wish to enter into a contract with the wireless carrier. The customer may then indicate “YES” or “NO” by interacting with the interface 208.

If the automated retailer machine 200 determines that a new cellular contract is needed, then at S422 the automated retailer machine 200 obtains cellular carrier information based on input from the customer via the interface 208. In one example, the cellular carrier information may include selection of a cellular carrier by the customer via the interface 208. The customer may be presented with one or more cellular carriers from which to select a desired cellular carrier.

At S424, the automated retailer machine 200 performs an Application Programming Interface (API) call to the selected cellular carrier (e.g., cellular carrier 106 in FIG. 1) based on the cellular carrier information to obtain the new cellular contract and an associated contract identifier (ID). As a result of the API call, the customer may interact (e.g., directly) with the cellular carrier systems to enter customer information (e.g., name, address, social security number, credit card or banking information, etc.) and execute the necessary documents (e.g., via electronic signature) via the interface 208 to enter into a contract with the cellular carrier and obtain a contract ID. Because such entry of information and execution of documents is generally known, further discussion is omitted. The contract ID is provided to the automated retailer machine 200 by the cellular carrier.

At S408, the automated retailer machine 200 stores the contract ID in, for example, the memory 704. The contract ID may be stored in association with purchase/transaction identification information (e.g., an identifier for the current transaction with the customer).

At S410, the automated retailer machine 200 obtains selection of a mobile device for purchase. In one example, the customer may interact with the interface 208 to select the mobile device by indicating the position of the desired device on a shelf within the automated retailer machine 200. Although described herein with regard to selection of a single mobile device, example embodiments should not be limited to this example. Rather, a customer may select one or more devices for activation and/or purchase.

At S412, the automated retailer machine 200 prompts the customer for payment for the selected mobile device via the interface 208 before dispensing. Also at S412, the customer provides payment for the selected device via the payment terminal 206.

Once payment is received, at S414 the automated retailer machine 200 determines or checks whether the device is being purchased with a contract (e.g., a new or existing contract) with the cellular carrier. In one example, the automated retailer machine 200 may determine whether the device is being purchased with a contract based on whether a contract ID for the current transaction is stored in the memory 704. If the contract ID for the current transaction is stored in the memory 704, then the automated retailer machine 200 determines that the device is being purchased with a contract. If the contract ID for the current transaction is not present in the memory 704, then the automated retailer machine 200 determines that the device is being purchased without a contract.

If the device is being purchased without a cellular contract, then at S418 the automated retailer machine 200 dispenses the device to the customer. For example, the controller 702 moves the hopper 2022 to the appropriate position or positions on the shelves holding the device, obtains the device from the shelf and moves the device to the dispensing window 210 for retrieval by the customer. The process then terminates and the automated retailer machine 200 may return the interface 208 to the “start” menu or advertisement display. If multiple devices are being purchased, the automated retailer machine 200 may dispense each device serially and then the process may terminate.

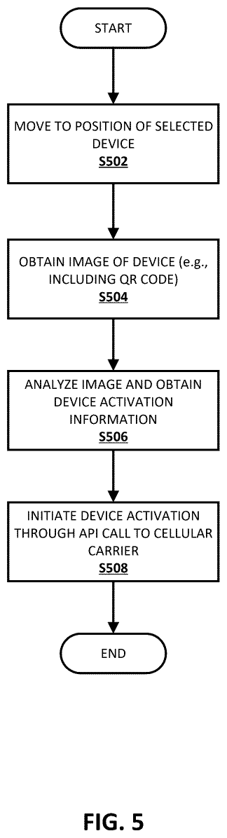

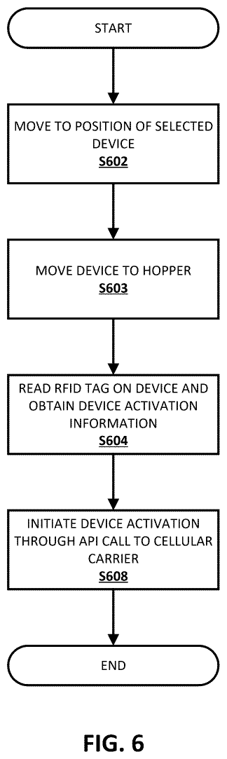

Returning to S414, if the automated retailer machine 200 determines that the device is being purchased with a contract, then at S416 the automated retailer machine 200 initiates activation of the device with the selected cellular carrier. In at least one example embodiment, the automated retailer machine 200 may initiate the activation based on device activation information obtained from the device, for example using the one or more capture devices 226. Example embodiments of methods for initiating device activation at S416 will be discussed in more detail later with regard to FIGS. 5 and 6.

After initiating the device activation, at S428 the automated retailer machine 200 determines whether the device activation was successful at the cellular carrier. In at least one example embodiment, upon successful device activation by the cellular carrier, the cellular carrier may send a signal or command to the automated retailer machine 200 indicating that the device has been successfully activated. If the device activation fails, then the cellular carrier may send a signal or command to the automated retailer machine 200 indicating that the device activation has failed (e.g., because an error has occurred). The automated retailer machine 200 may determine whether the device activation was successful based on the signal or command from the cellular carrier. Additionally, if the automated retailer machine 200 does not receive an indication whether the device activation is successful or has failed within a threshold period of time (e.g., 30 seconds, 60 seconds, etc.), the automated retailer machine 200 may determine that the device activation has failed. Upon determining that the device activation has failed, the automated retailer machine 200 may attempt to re-initiate device activation a threshold number (e.g., 2, 3, 4, etc.) of times before ultimately determining that the device activation has failed.

If the automated retailer machine 200 determines that the device activation was successful at S428, then the method proceeds to S418 and continues as discussed herein.

Returning to S428, if the automated retailer machine 200 determines that the device activation has failed, then at S430 the automated retailer machine 200 reports the device activation failure to the customer (e.g., via the interface 208). The interface 208 may also provide additional information, such as further information regarding the failed device activation that has occurred and/or instructions regarding how to retry the device activation and/or re-attempt to activate the device once the device is dispensed.

The process then proceeds to S418 and continues as discussed herein.

Returning now to S420 in FIG. 4, if the automated retailer machine 200 determines that a new cellular contract is not needed or desired, then at S426 the automated retailer machine 200 determines whether the device is to be purchased without a contract. In one example, the interface 208 may prompt the customer for input (‘YES’ or ‘NO’) regarding whether the device is to be purchased without a contract.

If the automated retailer machine 200 determines (e.g., via customer input) that the device is not to be purchased without a contract, then the process terminates and the automated retailer machine 200 may return the interface 208 to the “start” menu or advertisement display. In one example, the customer may select “NO” when prompted as to whether the device should be purchased without a cellular contract.

Returning to S426, if the automated retailer machine 200 determines that the customer wishes to purchase the device without a contract (e.g., via selection of “YES” by the customer when prompted), then the process proceeds to S410 and continues as discussed herein.

Returning now to S402 in FIG. 4, if the automated retailer machine 200 determines that the customer has an existing contract with the cellular carrier, then at S404 the automated retailer machine 200 obtains cellular carrier information based on input from the customer via the interface 208. The automated retailer machine 200 may obtain the cellular carrier information in the same or substantially the same manner as discussed above with regard to S422.

At S406, the automated retailer machine 200 performs an API call to the selected cellular carrier based on the cellular carrier information to obtain the contract ID for the existing contract between the customer and the cellular carrier. As discussed above with regard to S424, in S406 as a result of the API call, the customer may interact with (e.g., directly with) the cellular carrier systems to enter customer information (e.g., name, address, social security number, etc.). Based on the customer information, the cellular carrier provides the contract ID for the existing contract to the automated retailer machine 200. The process then proceeds to S408 and continues as discussed above.

FIG. 5 is a flow chart illustrating an example embodiment of a method for initiating device activation at S416 in FIG. 4. In this example, the one or more capture devices 226 include the camera 2026.

Referring to FIG. 5, at S502 the controller 702 moves the hopper 2022 to the position of the selected device on a shelf within the automated retailer machine 200. In at least one example, the controller 702 may move the hopper 2022 by utilizing the planogram for the automated retailer machine 200 stored in the planogram base 802.

At S504, the camera 2026 obtains an image of the selected device on the shelf. The image of the selected device includes at least the representation of the device activation information on an external surface of the device. The camera 2026 sends the captured image to the controller 702.

At S506, the controller 702 analyzes the image to obtain the device activation information based on the representation within the image. In an example in which the representation is a QR code encoding the device activation information, the controller 702 analyzes the captured image to read and interpret the QR code to obtain the device activation information for the selected device. As noted above, the device activation information may include the MEI, ESN, serial number, etc. for the selected device. The controller 702 may store the obtained device activation information in the memory 704.

In one example, if the controller 702 is unable to obtain the device activation information for the selected device, the automated retailer machine 200 may determine that the device activation for the selected device has failed. Alternatively, the controller 702 may instruct the camera 2026 to obtain a further image of the device and re-analyze the image. This may be repeated multiple times, for example, until the device activation information is obtained or until a threshold number of images (e.g., 2 or more) have been obtained and analyzed. If the threshold number of images is obtained without obtaining the device activation information, then the automated retailer machine 200 may determine that the device activation has failed.

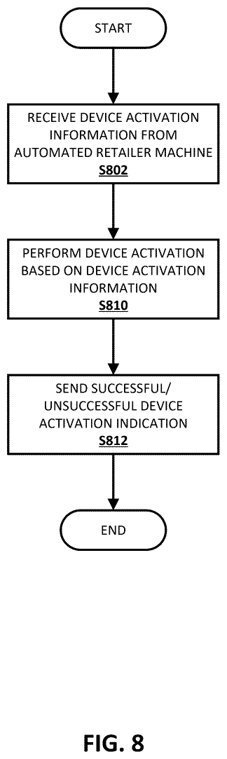

Still referring to FIG. 5, once having obtained the device activation information at S506, at S508 the automated retailer machine 200 performs an API call to the cellular carrier to initiate activation of the selected device. In one example, the automated retailer machine 200 sends the obtained device activation information to the cellular carrier through the API call to initiate activation of the selected device. As discussed in more detail later with regard to FIG. 8, in response to the API call, the cellular carrier attempts to activate the selected device based on the device activation information.

In another example embodiment, as discussed above with regard to FIG. 7, the one or more capture devices may include an optical scanner 2046 (e.g., a QR code or barcode reader) to read a machine readable code on the selected device. In this alternative example embodiment, rather than obtaining an image of the device and analyzing the image, the optical scanner 2046 may scan the machine readable code on the selected device to obtain the device activation information and initiate the device activation at the cellular carrier.

FIG. 6 is a flow chart illustrating another example embodiment of a method for initiating device activation at S416 in FIG. 4. In this example, the selected device has a RFID tag storing the device activation information and the automated retailer machine 200 uses the RFID reader 2036 to obtain the device activation information to activate the device.

Referring to FIG. 6, at S602 the controller 702 moves the hopper 2022 to the position of the selected device on the shelf in the same or substantially the same manner as discussed above with regard to S502 in FIG. 5.

At S603, the controller 702 causes the dispensing mechanism 2040 to move the selected device into the hopper 2022.

At S604, the RFID reader 2036 reads the RFID tag to obtain the device activation information for the selected device. Once obtained, the controller 702 may store the device activation information in the memory 704.

As with the example embodiment shown in FIG. 5, if the controller 702 is unable to obtain the device activation information for the selected device, the automated retailer machine 200 may determine that the device activation for the selected device has failed. Alternatively, the controller 702 may instruct the RFID reader 2036 to re-read the RFID tag multiple times, for example, until the device activation information is obtained or until a threshold number attempts to obtain the device activation information is reached. If the threshold number attempts is reached without obtaining the device activation information, then the automated retailer machine 200 may determine that the device activation has failed.

Once having obtained the device activation information at S604, at S608 the automated retailer machine 200 performs device activation through another API call in the same or substantially the same manner as discussed above with regard to S508 in FIG. 5.

FIG. 8 is a flow chart illustrating a method for device activation at the cellular carrier according to an example embodiment. For example purposes, the example embodiment shown in FIG. 8 will be discussed with regard to the cellular carrier 106 shown in FIG. 1. However, example embodiments should not be limited to this example.

Referring to FIG. 8, at S802 the cellular carrier 106 receives the device activation information from the automated retailer machine 200 via the API call at S508 in FIG. 5 or S608 in FIG. 6.

At S810, the cellular carrier 106 attempts to activate the selected device on the cellular carrier network (performs device activation) based on the received device activation information. In one example, the cellular carrier 106 may activate the SIM or e-SIM corresponding to the device activation information to enable the selected mobile device to access the cellular carrier's network and communicate wirelessly.

At S812, the cellular carrier 106 sends a signal or command to the automated retailer machine 200 indicating whether the device activation was successful or has failed.

Upon completing device activation (either successful or unsuccessful), the cellular carrier 106 sends an indication to the automated retailer machine 200 indicating whether the device activation was successful or unsuccessful.

Illustrative embodiment 1. An automatic retailer machine comprising: a shelf configured to hold a plurality of mobile devices; a dispensing window; a movable hopper assembly configured to move a mobile device, from among the plurality of mobile devices, from the shelf to the dispensing window to dispense the mobile device; and at least one processor configured to execute computer-executable instructions to control the movable hopper assembly to obtain device activation information from the mobile device, and cause the automatic retailer machine to initiate activation of the mobile device based on the device activation information.

Illustrative embodiment 2. The automatic retailer machine of illustrative embodiment 1, further comprising: an interface configured to receive a selection of the mobile device, from among the plurality of mobile devices, for dispensing.

Illustrative embodiment 3. The automatic retailer machine of illustrative embodiment 2, wherein the interface is configured to receive the selection of the mobile device via identification of a position of the mobile device on the shelf.

Illustrative embodiment 4. The automatic retailer machine of any of illustrative embodiments 1-3, wherein the movable hopper assembly includes an image capture device configured to obtain an image of the mobile device, the image of the mobile device including at least a representation of the device activation information, and the at least one processor is configured to execute the computer-executable instructions to analyze the image to obtain the device activation information.

Illustrative embodiment 5. The automatic retailer machine of illustrative embodiment 4, wherein the at least one processor is configured to execute the computer-executable instructions to cause the automatic retailer machine to initiate activation of the mobile device via an application programming interface call to a cellular carrier.

Illustrative embodiment 6. The automatic retailer machine of any of illustrative embodiments 4-5, wherein the at least one processor is configured to execute the computer-executable instructions to control the movable hopper assembly to move to a position at which the mobile device is stored on the shelf to obtain the image of the mobile device.

Illustrative embodiment 7. The automatic retailer machine of any of illustrative embodiments 4-6, wherein the representation of the device activation information is at least one of a machine readable code or a numerical code.

Illustrative embodiment 8. The automatic retailer machine of any of illustrative embodiments 1-7, wherein the mobile device includes an RFID tag indicative of the device activation information, and the movable hopper assembly includes a RFID reader configured to read the RFID tag to obtain the device activation information.

Illustrative embodiment 9. The automatic retailer machine of illustrative embodiment 8, wherein the at least one processor is configured to execute the computer-executable instructions to cause the automatic retailer machine to initiate activation of the mobile device via an application programming interface call to a cellular carrier.

Illustrative embodiment 10. The automatic retailer machine of any of illustrative embodiments 1-9, further comprising: a display device; and wherein the at least one processor is configured to execute the computer-executable instructions to cause the automatic retailer machine to determine that the activation was unsuccessful, and display, via the display device, a device activation error in response to determining that the activation was unsuccessful.

Illustrative embodiment 11. The automatic retailer machine of any of illustrative embodiments 1-10, wherein the at least one processor is configured to execute the computer-executable instructions to cause the automatic retailer machine to obtain cellular carrier contract information for the mobile device, and initiate activation based on the device activation information and the cellular carrier contract information.

Illustrative embodiment 12. The automatic retailer machine of illustrative embodiment 11, wherein the cellular carrier contract information is associated with an existing cellular carrier contract, and the at least one processor is configured to execute the computer-executable instructions to cause the automatic retailer machine to obtain the cellular carrier contract information by performing an application programming interface call to a cellular carrier.

Illustrative embodiment 13. The automatic retailer machine of any of illustrative embodiments 11-12, wherein the at least one processor is configured to execute the computer-executable instructions to cause the automatic retailer machine to obtain the cellular carrier contract information by obtaining cellular carrier information, performing an application programming interface call to a cellular carrier to obtain a cellular carrier contract and cellular carrier contract information.

Illustrative embodiment 14. A non-transitory computer-readable storage medium storing computer-executable instructions that, when executed by at least one processor at an automatic retailer machine including at least one shelf holding a plurality of mobile devices, cause the automatic retailer machine to perform a method comprising: moving a movable hopper assembly to a shelf position at which a mobile device is arranged; obtaining device activation information from the mobile device; initiating activation of the mobile device based on the device activation information; and moving the mobile device from the shelf position to a dispensing window to dispense the mobile device.

Illustrative embodiment 15. The non-transitory computer-readable storage medium of illustrative embodiment 14, wherein the method further comprises: receiving a selection of the mobile device, from among the plurality of mobile devices, for dispensing.

Illustrative embodiment 16. The non-transitory computer-readable storage medium of illustrative embodiment 15, wherein the receiving receives the selection of the mobile device via identification of a position of the mobile device on the shelf.

Illustrative embodiment 17. The non-transitory computer-readable storage medium of any of illustrative embodiments 14-16, wherein the obtaining comprises: obtaining an image of the mobile device via an image capture device, the image of the mobile device including at least a representation of the device activation information; and analyzing the image to obtain the device activation information.

Illustrative embodiment 18. The non-transitory computer-readable storage medium of illustrative embodiment 17, wherein the initiating initiates activation of the mobile device via an application programming interface call to a cellular carrier.

Illustrative embodiment 19. The non-transitory computer-readable storage medium of illustrative embodiment 17, wherein the moving moves the movable hopper assembly to a position at which the mobile device is stored on the shelf to obtain the image of the mobile device.

Illustrative embodiment 20. A method of operating an automatic retailer machine including at least one shelf holding a plurality of mobile devices, the method comprising: moving a movable hopper assembly to a shelf position at which a mobile device is arranged; obtaining device activation information from the mobile device; initiating activation of the mobile device based on the device activation information; and moving the mobile device from the shelf position to a dispensing window to dispense the mobile device.

Although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of this disclosure. As used herein, the term “and/or,” includes any and all combinations of one or more of the associated listed items.

When an element is referred to as being “connected,” or “coupled,” to another element, it can be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of example embodiments. However, it will be understood by one of ordinary skill in the art that example embodiments may be practiced without these specific details. For example, systems may be shown in block diagrams so as not to obscure the example embodiments in unnecessary detail. In other instances, well-known processes, structures and techniques may be shown without unnecessary detail in order to avoid obscuring example embodiments.

As discussed herein, illustrative embodiments will be described with reference to acts and symbolic representations of operations (e.g., in the form of flow charts, flow diagrams, data flow diagrams, structure diagrams, block diagrams, etc.) that may be implemented as program modules or functional processes include routines, programs, objects, components, data structures, etc., that perform particular tasks or implement particular abstract data types and may be implemented using existing hardware, for example, processing or control circuitry such as, but not limited to, one or more processors, one or more Central Processing Units (CPUs), one or more controllers, one or more arithmetic logic units (ALUs), one or more digital signal processors (DSPs), one or more microcomputers, one or more field programmable gate arrays (FPGAs), one or more System-on-Chips (SoCs), one or more programmable logic units (PLUs), one or more microprocessors, one or more Application Specific Integrated Circuits (ASICs), or any other device or devices capable of responding to and executing instructions in a defined manner.

Although a flow chart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

As disclosed herein, the term “memory,” “storage medium,” “processor readable medium,” “computer readable storage medium” or “non-transitory computer readable storage medium” may represent one or more devices for storing data, including read only memory (ROM), random access memory (RAM), magnetic RAM, core memory, magnetic disk storage mediums, optical storage mediums, flash memory devices and/or other tangible machine-readable mediums for storing information. The term “computer-readable medium” may include, but is not limited to, portable or fixed storage devices, optical storage devices, and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a computer readable storage medium. When implemented in software, a processor or processors will perform the necessary tasks. For example, as mentioned above, according to one or more example embodiments, at least one memory may include or store computer program code, and the at least one memory and the computer program code may be configured to, with at least one processor, cause a network element or network device to perform the necessary tasks. Additionally, the processor, memory and example algorithms, encoded as computer program code, serve as means for providing or causing performance of operations discussed herein.

The terms “including” and/or “having,” as used herein, are defined as comprising (i.e., open language). The term “coupled,” as used herein, is defined as connected, although not necessarily directly, and not necessarily mechanically. Terminology derived from the word “indicating” (e.g., “indicates” and “indication”) is intended to encompass all the various techniques available for communicating or referencing the object/information being indicated. Some, but not all, examples of techniques available for communicating or referencing the object/information being indicated include the conveyance of the object/information being indicated, the conveyance of an identifier of the object/information being indicated, the conveyance of information used to generate the object/information being indicated, the conveyance of some part or portion of the object/information being indicated, the conveyance of some derivation of the object/information being indicated, and the conveyance of some symbol representing the object/information being indicated.

According to example embodiments, medical systems, may be (or include) hardware, firmware, hardware executing software or any combination thereof. Such hardware may include processing or control circuitry such as, but not limited to, one or more processors, one or more CPUs, one or more controllers, one or more ALUs, one or more DSPs, one or more microcomputers, one or more FPGAs, one or more SoCs, one or more PLUs, one or more microprocessors, one or more ASICs, or any other device or devices capable of responding to and executing instructions in a defined manner.

Benefits, other advantages, and solutions to problems have been described above with regard to specific embodiments. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

What is claimed is:

1. An automatic retailer machine comprising:
a shelf configured to hold a plurality of mobile devices;
a dispensing window;
a movable hopper assembly configured to move a mobile device, from among the plurality of mobile devices, from the shelf to the dispensing window to dispense the mobile device; and
at least one processor configured to execute computer-executable instructions to
control the movable hopper assembly to obtain device activation information from the mobile device, and
cause the automatic retailer machine to initiate activation of the mobile device based on the device activation information.

2. The automatic retailer machine of claim 1, further comprising:
an interface configured to receive a selection of the mobile device, from among the plurality of mobile devices, for dispensing.

3. The automatic retailer machine of claim 2, wherein the interface is configured to receive the selection of the mobile device via identification of a position of the mobile device on the shelf.

4. The automatic retailer machine of claim 1, wherein
the movable hopper assembly includes an image capture device configured to obtain an image of the mobile device, the image of the mobile device including at least a representation of the device activation information, and
the at least one processor is configured to execute the computer-executable instructions to analyze the image to obtain the device activation information.

5. The automatic retailer machine of claim 4, wherein the at least one processor is configured to execute the computer-executable instructions to cause the automatic retailer machine to initiate activation of the mobile device via an application programming interface call to a cellular carrier.

6. The automatic retailer machine of claim 4, wherein the at least one processor is configured to execute the computer-executable instructions to control the movable hopper assembly to move to a position at which the mobile device is stored on the shelf to obtain the image of the mobile device.

7. The automatic retailer machine of claim 4, wherein the representation of the device activation information is at least one of a machine readable code or a numerical code.

8. The automatic retailer machine of claim 1, wherein
the mobile device includes an RFID tag indicative of the device activation information, and
the movable hopper assembly includes a RFID reader configured to read the RFID tag to obtain the device activation information.

9. The automatic retailer machine of claim 8, wherein the at least one processor is configured to execute the computer-executable instructions to cause the automatic retailer machine to initiate activation of the mobile device via an application programming interface call to a cellular carrier.

10. The automatic retailer machine of claim 1, further comprising:
a display device; and wherein
the at least one processor is configured to execute the computer-executable instructions to cause the automatic retailer machine to
determine that the activation was unsuccessful, and
display, via the display device, a device activation error in response to determining that the activation was unsuccessful.

11. The automatic retailer machine of claim 1, wherein the at least one processor is configured to execute the computer-executable instructions to cause the automatic retailer machine to
obtain cellular carrier contract information for the mobile device, and
initiate activation based on the device activation information and the cellular carrier contract information.

12. The automatic retailer machine of claim 11, wherein
the cellular carrier contract information is associated with an existing cellular carrier contract, and
the at least one processor is configured to execute the computer-executable instructions to cause the automatic retailer machine to obtain the cellular carrier contract information by performing an application programming interface call to a cellular carrier.

13. The automatic retailer machine of claim 11, wherein the at least one processor is configured to execute the computer-executable instructions to cause the automatic retailer machine to obtain the cellular carrier contract information by
obtaining cellular carrier information,
performing an application programming interface call to a cellular carrier to obtain a cellular carrier contract and cellular carrier contract information.

14. A non-transitory computer-readable storage medium storing computer-executable instructions that, when executed by at least one processor at an automatic retailer machine including at least one shelf holding a plurality of mobile devices, cause the automatic retailer machine to perform a method comprising:
moving a movable hopper assembly to a shelf position at which a mobile device is arranged;
obtaining device activation information from the mobile device;
initiating activation of the mobile device based on the device activation information; and
moving the mobile device from the shelf position to a dispensing window to dispense the mobile device.

15. The non-transitory computer-readable storage medium of claim 14, wherein the method further comprises:
receiving a selection of the mobile device, from among the plurality of mobile devices, for dispensing.

16. The non-transitory computer-readable storage medium of claim 15, wherein the receiving receives the selection of the mobile device via identification of a position of the mobile device on the shelf.

17. The non-transitory computer-readable storage medium of claim 14, wherein the obtaining comprises:
obtaining an image of the mobile device via an image capture device, the image of the mobile device including at least a representation of the device activation information; and
analyzing the image to obtain the device activation information.

18. The non-transitory computer-readable storage medium of claim 17, wherein the initiating initiates activation of the mobile device via an application programming interface call to a cellular carrier.

19. The non-transitory computer-readable storage medium of claim 17, wherein the moving moves the movable hopper assembly to a position at which the mobile device is stored on the shelf to obtain the image of the mobile device.

20. A method of operating an automatic retailer machine including at least one shelf holding a plurality of mobile devices, the method comprising:
moving a movable hopper assembly to a shelf position at which a mobile device is arranged;
obtaining device activation information from the mobile device;
initiating activation of the mobile device based on the device activation information; and
moving the mobile device from the shelf position to a dispensing window to dispense the mobile device.
